(19) United States
(12) Patent Application Publication
(10) Pub. No.: US 2025/0042100 A1
(43) Pub. Date: Feb. 6, 2025

(54) SYSTEM AND METHOD FOR FLAT PANEL FABRICATION OF COMPOSITE STRUCTURES

(71) Applicant: Jonathan L. Corsico, Potomac, MD (US)

(72) Inventor: Jonathan L. Corsico, Potomac, MD (US)

(73) Assignee: Corsico Grand Prix, LLC, Potomac, MD (US)

(21) Appl. No.: 18/791,711

(22) Filed: Aug. 1, 2024

Related U.S. Application Data
(60) Provisional application No. 63/530,148, filed on Aug. 1, 2023.

(51) Int. Cl. B29C 65/00; B29C 65/54

(52) U.S. Cl. CPC B29C 66/2274; B29C 65/54; B29C 66/02241; B29C 66/721

(57) ABSTRACT

A system and methods are provided for fabricating structures by using flat composite panels that include interlocking edge features. The system includes two or more composite flat panels cut into individual shapes that include interlocking edge features along at least one edge of each panel. The interlocking edge features may be dovetails that mesh with one another. The panels may be cut by way of at least a 4-axis computer controlled cutting machine. The interlocking edge features may have a shape such that the assembled panels have a degree of freedom in only one plane of motion that allows the interlocking edge features to be meshed together. The interlocking edge features may be configured to mesh at a desired angle relative to either of the panels. The interlocking edge features may provide an edge joint that is disposed at a compound angle. An adhesive permanently affixes the interlocking edge features.

### PRIORITY

This application claims the benefit of and priority to U.S. Provisional Application, entitled “System And Method For Flat Panel Fabrication Of Composite Structures,” filed on Aug. 1, 2023, and having application Ser. No. 63/530,148, the entirety of said application being incorporated herein by reference.

### FIELD

Embodiments of the present disclosure generally relate to fabrication of composite structures. More specifically, embodiments of the disclosure relate to a system and methods for designing and fabricating structures by using flat composite panels that include interlocking edge features.

### BACKGROUND

Composites, such as carbon fiber reinforced epoxy or fiberglass reinforced vinyl ester, are used in a wide variety of high-performance applications where strength and low weight are priorities. For example, composites are widely used in aerospace (e.g., planes, missiles, spacecraft, etc.), marine (e.g., recreational boats, commercial ships, sailing vessels, fishing gear, etc.), sports (e.g., skis, golf clubs, padding, etc.), automotive (e.g., cars, race cars, trucks, etc.) and industrial (e.g., tools, trains and rail, wind power, etc.).

One of the downsides of composites is that they are often expensive in comparison to more traditional materials and methods of construction. The raw materials are expensive, and the labor required to turn those raw materials into a finished product is often considerable.

The large majority of composite structures are built using a mold. To create a composite structure using a mold, the mold must first be designed and then fabricated. Second, the composite material (resin plus a reinforcement) must be applied to the mold. This application process can be very labor intensive, particularly in high performance applications where light weight is a priority. Third, the composite material must be cured, sometimes at room temperature, but often at an elevated temperature and sometimes even at an elevated pressure inside an autoclave. Fourth, the cured composite must be removed from the mold, trimmed, and then usually adhered to other composite parts to make a complete structure.

This traditional fabrication process can result in a reliable and high-performance product, but at a high cost—both in terms of upfront capital expenditures (e.g., the molds, autoclaves, and other tooling) and in terms of labor. The traditional fabrication process also tends to be quite time consuming, making it difficult to produce a large number of composite parts quickly.

Accordingly, there is a need to improve the methods used for designing and fabricating composite structures. This will make composite structures more affordable. Embodiments disclosed herein provide a system and method for designing and fabricating composite structures using only flat composite panels that are joined with interlocking edge features and adhesive. In comparison to traditional methods of composite fabrication, the embodiments disclosed herein are less capital intensive, faster, and require less skilled labor, with the result being a less expensive composite structure.

### SUMMARY

A system and methods are provided for fabricating structures by using flat composite panels that include interlocking edge features. The system includes two or more composite flat panels cut into individual shapes that include interlocking edge features along at least one edge of each panel. The interlocking edge features may be dovetails that mesh with one another. The panels may be cut by way of at least a 4-axis computer controlled cutting machine. The interlocking edge features may have a shape such that the assembled panels have a degree of freedom in only one plane of motion that allows the interlocking edge features to be meshed together. The interlocking edge features may be configured to mesh at a desired angle relative to either of the panels. The interlocking edge features may provide an edge joint that is disposed at a compound angle. An adhesive permanently affixes the interlocking edge features.

In an exemplary embodiment, a system for constructing composite structures comprises: two or more composite panels that are flat; interlocking edge features for joining the two or more composite panels; and an adhesive for permanently affixing the interlocking edge features.

In another exemplary embodiment, the interlocking edge features are cut by way of at least a 4-axis computer controlled cutting machine. In another exemplary embodiment, the interlocking edge features have a shape that is configured such that the assembled two or more composite panels have a degree of freedom in only one plane of motion that allows the interlocking edge features to be meshed together.

In another exemplary embodiment, the interlocking edge features are configured to mesh at an angle relative to a plane of either one of the two or more composite panels. In another exemplary embodiment, the angle ranges between about 0 degrees and about 90 degrees. In another exemplary embodiment, the angle ranges between greater than 90 degrees and less than 180 degrees. In another exemplary embodiment, the interlocking edge features are configured to mesh such that the two or more composite panels are disposed at an angle with respect to one another. In another exemplary embodiment, the interlocking edge features are configured to provide an edge joint that is disposed at a compound angle.

In an exemplary embodiment, a method for constructing composite structures comprises: constructing two or more composite panels that are flat; cutting the two or more composite panels into individual shapes; cutting interlocking edge features for joining the two or more composite panels; assembling the two or more composite panels; and curing an adhesive for permanently affixing the two or more composite panels.

In another exemplary embodiment, cutting the two or more composite panels includes using at least a 4-axis cutting machine, such as a tilting head waterjet. In another exemplary embodiment, cutting the interlocking edge features comprises configuring the interlocking edge features to mesh such that the two or more composite panels are disposed at an angle with respect to one another. In another exemplary embodiment, cutting the interlocking edge features comprises configuring the interlocking edge features to provide an edge joint that is disposed at a compound angle.

In another exemplary embodiment, cutting the interlocking edge features includes cutting dovetails into at least one edge of each of the two more composite panels. In another exemplary embodiment, cutting the dovetails includes cutting the dovetails such that the interlocking edge features mesh at an angle relative to a plane of either one of the two or more composite panels. In another exemplary embodiment, the angle ranges between greater than 0 degrees and less than 180 degrees.

In another exemplary embodiment, assembling includes applying an adhesive to the interlocking edge features. In another exemplary embodiment, assembling includes meshing the interlocking edge features such that the adhesive fills any gaps and bonds the two more composite panels together.

In another exemplary embodiment, curing the adhesive includes using a room temperature cure. In another exemplary embodiment, curing the adhesive includes using one or more external jigs to fixate the two or more composite panels while the adhesive cures. In another exemplary embodiment, curing the adhesive includes removing any adhesive that squeezed out of the joints.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1A illustrates an isometric view of an exemplary embodiment of a composite structure that was designed and fabricated in accordance with the present disclosure;

FIG. 1B illustrates a front view of the composite structure of FIG. 1A, in accordance with the present disclosure;

FIG. 1C illustrates a righthand side view of the composite structure of FIG. 1A, in accordance with the present disclosure;

FIG. 1D illustrates a top view of the composite structure of FIG. 1A, according to the present disclosure;

FIG. 2 illustrates an isometric view of an exemplary embodiment of an interlocking edge feature implemented in a flat, one-dimensional joint;

FIG. 3 illustrates an isometric view of an exemplary embodiment of an interlocking edge feature implemented in a two dimensional, 90-degree joint;

FIG. 4A illustrates an isometric view of an exemplary embodiment of an interlocking edge feature implemented in a three-dimensional, compound angled joint;

FIG. 4B illustrates a front view of the interlocking edge feature shown in FIG. 4A;

FIG. 4C illustrates an exploded isometric view of the interlocking edge feature shown in FIG. 4A;

FIG. 4D illustrates an exploded front view of the interlocking edge feature shown in FIG. 4A;

FIG. 5A illustrates an interior view of an exemplary embodiment of a three-dimensional structure that comprises numerous compound angle joints, in accordance with the present disclosure;

FIG. 5B illustrates an exterior view of the three-dimensional structure of FIG. 5A, according to the present disclosure; and

FIG. 6 is a flowchart illustrating an exemplary embodiment of a process for

fabricating structures made from flat composite panels, according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the system and methods disclosed herein may be practiced without these specific details. In other instances, specific numeric references such as “first panel,” may be made. However, the specific numeric reference should not be interpreted as a literal sequential order but rather interpreted that the “first panel” is different than a “second panel.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Composites, such as carbon fiber reinforced epoxy or fiberglass reinforced vinyl ester, are used in a wide variety of high-performance applications where strength and low weight are priorities. One of the downsides of composites is that the process for fabricating composite parts comes with a high cost—both in terms of upfront capital expenditures and in terms of labor. The traditional fabrication process also tends to be quite time consuming, making it difficult to produce a large number of composite parts quickly. Accordingly, there is a need to improve the methods used for designing and fabricating composite structures. This will make composite structures more affordable. Embodiments disclosed herein provide a system and methods for fabricating composite structures that are less capital intensive, faster, require less skilled labor, and result in comparatively inexpensive composite structures.

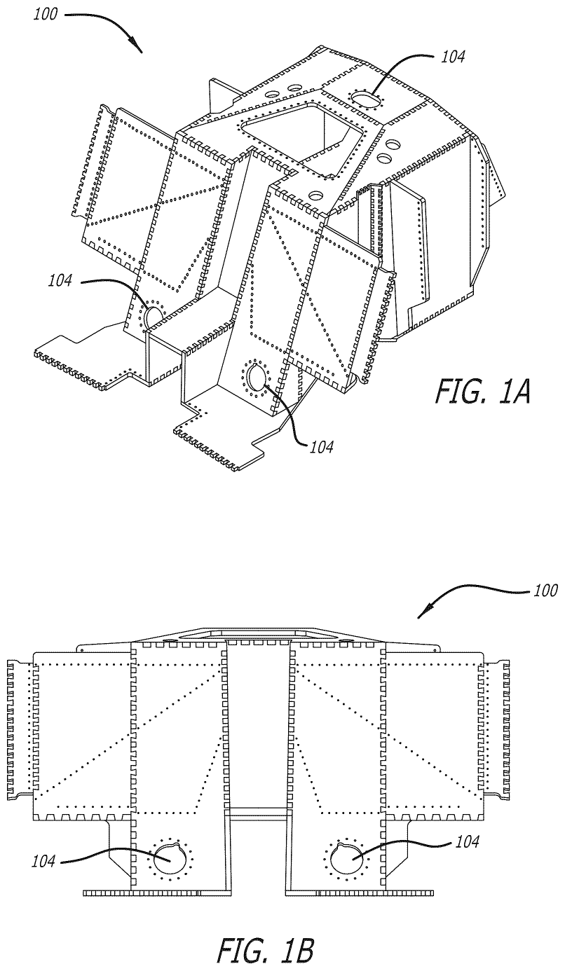

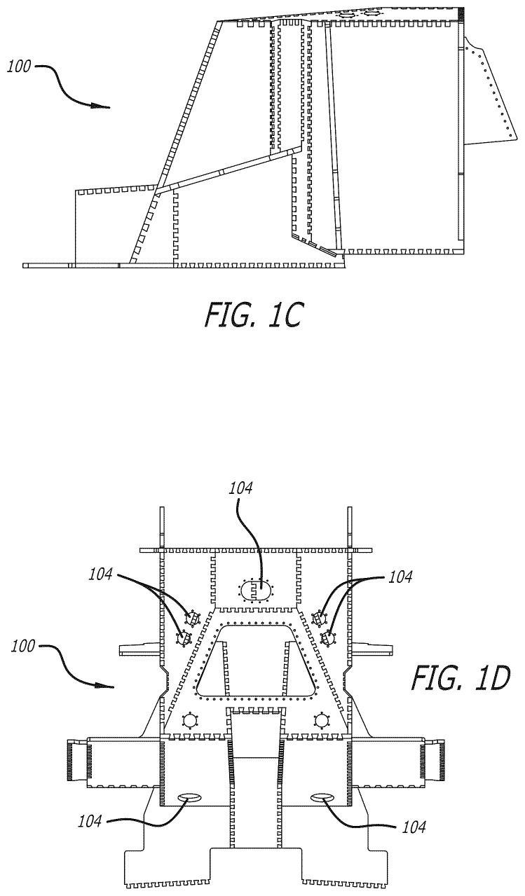

FIGS. 1A through 1D illustrate an exemplary embodiment of a composite structure 100 that was designed and fabricated using the system and method of the present disclosure. Specifically, composite structure 100 is part of an off-road racing vehicle. Composite structure 100 performs two primary functions: (i) it is part of the chassis of the off-road vehicle, carrying chassis loads and serving as a mounting point for other components; and (ii) it encloses the fuel tank.

Composite structure 100 is composed of 54 individual flat panels. All of these flat panels were constructed using the system and method of the present disclosure. The structure includes holes 104 that are configured to enable mounting the structure 100 to a metal subframe of the vehicle. Some of the panels are solid carbon fiber reinforced epoxy, while other panels are of a ‘sandwich’ construction, where carbon fiber reinforced epoxy face sheets sandwich a core material of balsa wood. Importantly, all panels are flat and were cured against a flat tooling surface in an oven under vacuum pressure. No mold was required. No autoclave was required. Additionally, all of the panels are ‘self-fixturing’ and no jig or fixture (other than customary woodworking clamps) was required to hold the panels in position while the adhesive cured.

In composite structure 100, the vast majority of the flat panels are joined together using the system and method of interlocking edge features described in the present disclosure. As can be seen, however, a handful of panels nay be joined using traditional butt or overlap joints, or mortise and tenon joints, rather than interlocking edge features. Such joints may be advantageous in instances wherein using interlocking edge features on all panel edges may result in the structure 100 being incapable of assembly—in other words, if interlocking edge features were included on all panel edges, then there would have been no degrees of freedom whatsoever, making it impossible to actually mesh the panels together.

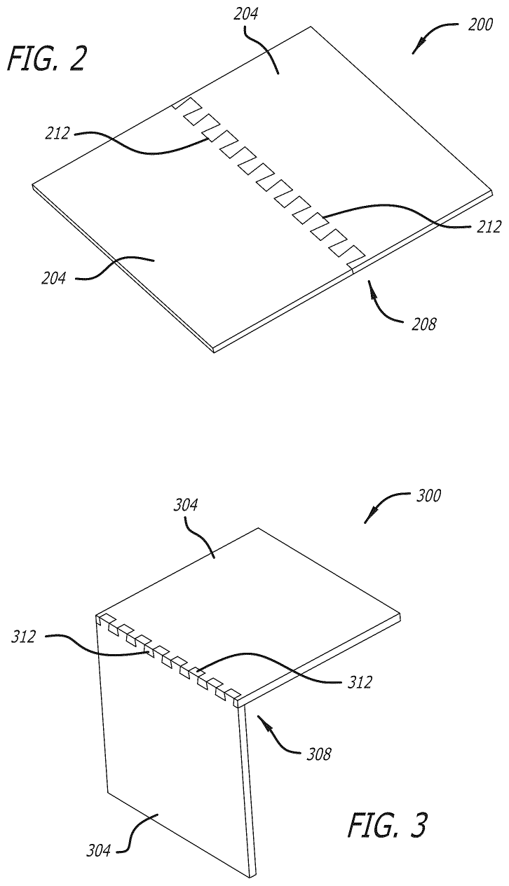

FIG. 2 illustrates an exemplary embodiment of a composite structure 200. Composite structure 200 illustrates the joining of two flat panels 204 in a one-dimensional joint 208, that replaces a traditional butt joint. The flat panels 204 of composite structure 200 were constructed using the system and method of the present disclosure. These panels 204 could be solid composite or could be sandwich.

Composite structure 200 includes dovetails 212 as the interlocking edge features. These dovetails 212 are cut at a 90-degree angle to the flat panel 204 (as is done with dovetail joints used in traditional carpentry). Alternatively, the dovetails 212 could be cut at a different angle (which would be functionally impossible to perform without a 4+ axis computer controlled cutting machine), depending on the properties that were desired from the joint. If the dovetails 212 are cut at a 90-degree angle, normal to the plane of the panel 204, that would maximize the structure's 200 in-plane strength, as the interlocking nature of the dovetails 212 would carry the load. But it would also result in the minimum amount of strength in the normal direction, as there is no interlocking feature in the normal direction, and it is merely the adhesive alone that carries that load.

Similarly, if the dovetails 212 of composite structure 200 were cut at a different angle (i.e., an angle that is not normal to the plane of the panels 204), that would result in interlocking features for both in-plane and normal loads. This would allow the panel 204 to better resist both types of loads but would still present the weakest joint along the single degree of freedom used for assembly.

FIG. 3 shows a detailed view of composite structure 300. Composite structure 300 illustrates the joining of two flat panels 304 in a two-dimensional 90-degree corner joint 308. The flat panels 304 of composite structure 300 were constructed using the system and method of the present disclosure. These panels could be solid composite or could be sandwich.

Composite structure 300 uses dovetails 312 as the interlocking edge features. These dovetails 312 are cut at a 90-degree angle to each flat panel 304 (as is done with dovetail joints used in traditional carpentry). Alternatively, the dovetails 312 could be cut at a different angle (which would be functionally impossible to perform without a 4+ axis computer controlled cutting machine), depending on the properties that were desired from the joint 308. As shown with composite structure 200, shown in FIG. 2, maximum strength is obtained when the loads are resisted by the interlocking nature of the joint, and minimum strength is obtained when the loads are resisted by the adhesive alone.

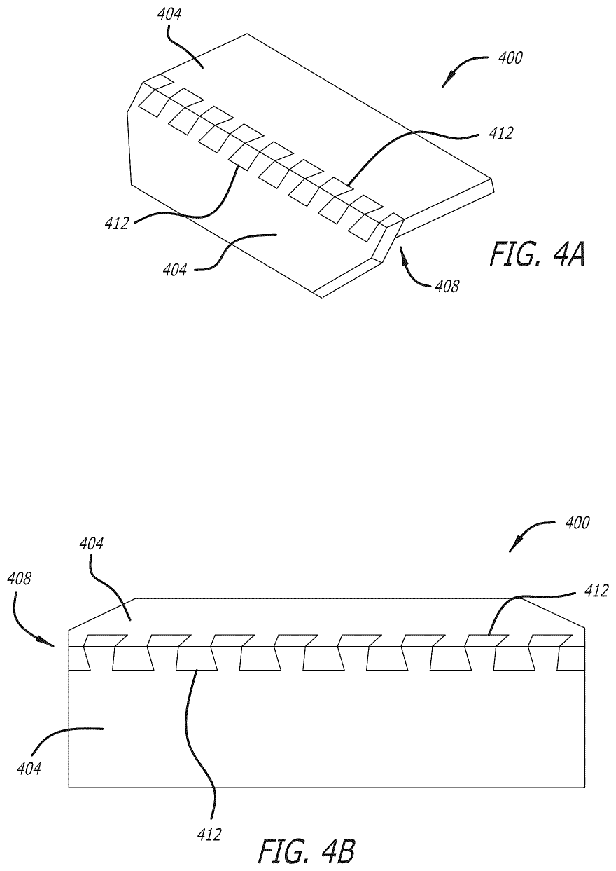

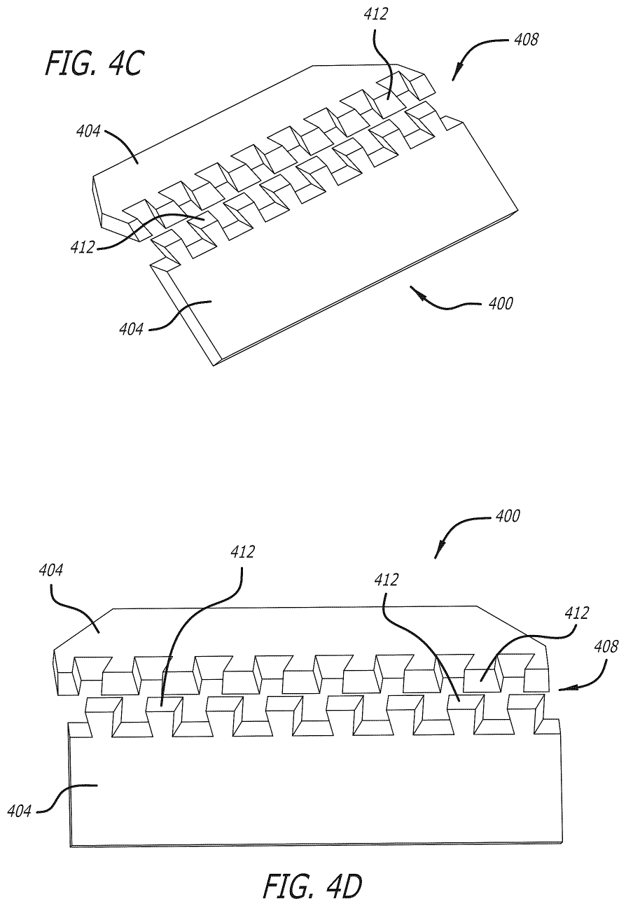

FIGS. 4A through 4D show illustrate an exemplary embodiment of a composite structure 400. Composite structure 400 illustrates the joining of two flat panels 404 in a joint 408 where dovetails 412 are cut at an angle other than 90 degrees to either the plane of the panels 404 or the edge of joint 408 (i.e., the dovetails 412 are cut at a compound angle). The flat panels 404 of composite structure 400 were constructed using the system and method of the present disclosure. These panels 404 could be solid composite or could be sandwich.

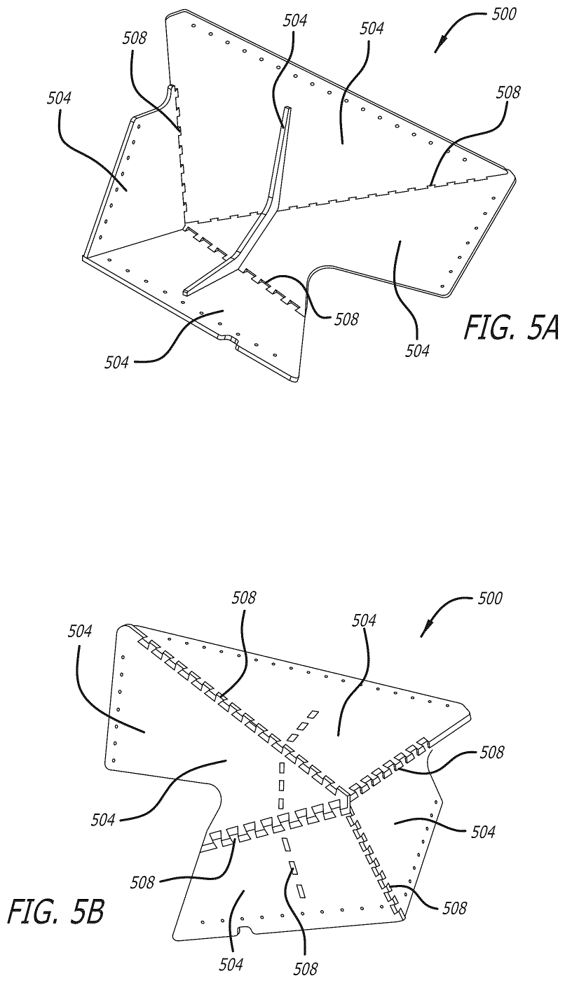

FIGS. 5A and 5B illustrate an exemplary embodiment of a composite structure 500 comprising numerous compound angle joints, in accordance with the present disclosure. Similar to composite structure 400, composite structure 500 comprises flat panels 504 that are joined by way of dovetails 508 that are cut at compound angles. The flat panels 504 of composite structure 500 were constructed using the system and method of the present disclosure. These panels 504 could be solid composite or could be sandwich.

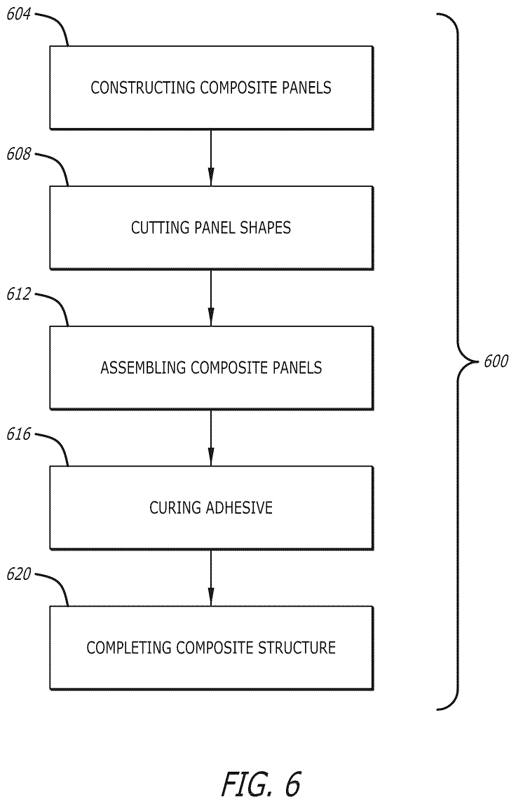

FIG. 6 is a flowchart illustrating an exemplary embodiment of a process 600 for fabricating structures made from flat composite panels as described herein. The process 600 may begin with a step 604, wherein composite panels are constructed against a flat tooling surface, such as a table. The composite panels may be cured in this flat state. Depending on the resin system used, this could be a cure at room temperature, at an elevated temperature, or at both an elevated temperature and an elevated pressure. If an elevated temperature cure is required, it can be applied using any reasonable means, such as an oven, heat blankets or heat lamps. If an elevated pressure cure is desired, it can be applied using any reasonable method, such as a vacuum bag, press or autoclave. In general, manufacturing the panels using a heated press affords the most cost-effective result, as the press applies both heat and pressure and yet is significantly less expensive than an autoclave.

In step 608, the panels may be cut into individual shapes using a 4-axis (or greater) cutting machine, such as a tilting head waterjet. Small features, such as dovetails, are cut into the edge of each panel. These features are designed to interlock with comparable features on an adjacent panel. When the edge features of one panel are meshed with the edge features of an adjacent panel, the features lock together resulting in a joint that cannot pull apart (i.e., it has no degrees of freedom), except if moved along the exact plane of motion that allows it to be assembled.

Once the panels are cut and test fitted together, an adhesive may be applied to the interlocking edge features in step 612. Adjacent panels may be brought together, and the edge features meshed, with adhesive filling any gaps and bonding the panels together. As described above, the edge features interlock, such that the adhesive's primary functions are to (1) fill gaps and (2) resist motion along the single degree of freedom that allows the panels to be assembled. Additionally, the interlocking edge features provide a large surface area for adhesive, much larger than could be obtained with a straight edge.

The adhesive may be cured in step 616. Depending on the adhesive used, this can be a room temperature cure or an elevated temperature cure. Depending on the overall shape of the structure and the amount of clearance included between the interlocking edge features (if any), the composite structure may be ‘self-fixturing’. If this is the case, then no external jigs are required to hold the structure in place while the adhesive cures.

Once the adhesive is cured, the composite structure is complete in step 620. While it may be necessary, in some embodiments, to remove adhesive that squeezed out of the joints, it is contemplated that the structure is unlikely to require significant trimming, like that typically required with structures built in molds where flash must be removed.

In some embodiments, a computer controlled 4-axis (or greater) cutting tool, such as a tilting head waterjet, may be used for cutting the interlocking edge features. It is contemplated that using a computer-controlled tool for the cuts will provide optimal accuracy and speed. As will be appreciated, cutting the dovetails manually with a chisel and other hand tools (as done in traditional carpentry) would be impossible because composites are too hard and brittle to be cut using those methods. Further, manual cutting would be too slow, given the large number of interlocking features required.

In theory, it would be possible to use a router or other rotating cutting tool to cut the interlocking edge features, like the routers commonly used in woodworking to cut dovetails. But this approach has two distinct downsides: First, it is difficult to orient the flat panels for cutting, as the rotating axis of the cutting tool needs to be parallel to the plane of the panel in order to cut an acceptable interlocking feature. In other words, the panel must be stood up on its edge, and then cut in that standing position with the router balanced on the panel's edge. This is not how routers are traditionally designed to work. Instead, routers are traditionally designed to cut with the axis of the cutting tool being normal to (rather than parallel to) the plane of the flat panel, which allows the router to ride along the large flat surface of the panel, rather than being balanced on the panel's edge. Second, a rotating cutting tool is limited in the shapes that it can cut—namely, it can only cut one shape—the shape outlined by the rotating cutter. A point cutter like a waterjet is much more flexible, and thus enables the fabrication of a much wider range of interlocking features.

The interlocking edge features of the present disclosure can be any number of shapes, such as dovetail, rectangular (i.e., mortise and tenon), or triangular (i.e., finger joints). That said, the dovetail is of particular utility, because it provides a large amount of interlocking and a large surface area for adhesive.

In general, it is advantageous to make the interlocking features as numerous as possible. More interlocking features results in more surface area in the joint, which in turn results in more adhesive in the joint. More interlocking features also result in a more even distribution of load through the joint.

If dovetails are used, the angle of the dovetails can be adjusted as well. Traditional carpentry typically uses dovetail angles between 10 and 20 degrees. Depending on the nature of the joint and the loads it is intended to carry, it may be desirable to use a steeper angle (e.g., 30 degrees, 45 degrees, 60 degrees, etc.) or a longer or shorter dovetail. The best shape for any particular joint will be based on the specific design considerations of that joint.

While the panel fabrication system and methods have been described in terms of particular variations and illustrative figures, those of ordinary skill in the art will recognize that the panel fabrication system is not limited to the variations or figures described. In addition, where methods and steps described above indicate certain events occurring in certain order, those of ordinary skill in the art will recognize that the ordering of certain steps may be modified and that such modifications are in accordance with the variations of the panel fabrication system. Additionally, certain of the steps may be performed concurrently in a parallel process, when possible, as well as performed sequentially as described above. To the extent there are variations of the panel fabrication system, which are within the spirit of the disclosure or equivalent to the panel fabrication system found in the claims, it is the intent that this patent will cover those variations as well. Therefore, the present disclosure is to be understood as not limited by the specific embodiments described herein, but only by scope of the appended claims.

What is claimed is:

1. A system for constructing composite structures, comprising:
two or more composite panels that are flat;
interlocking edge features for joining the two or more composite panels; and
an adhesive for permanently affixing the interlocking edge features.

2. The system of claim 1, wherein the interlocking edge features are cut by way of at least a 4-axis computer controlled cutting machine.

3. The system of claim 1, wherein the interlocking edge features have a shape that is configured such that the assembled two or more composite panels have a degree of freedom in only one plane of motion that allows the interlocking edge features to be meshed together.

4. The system of claim 1, wherein the interlocking edge features are configured to mesh at an angle relative to a plane of either one of the two or more composite panels.

5. The system of claim 4, wherein the angle ranges between about 0 degrees and about 90 degrees.

6. The system of claim 5, wherein the angle ranges between greater than 90 degrees and less than 180 degrees.

7. The system of claim 1, wherein the interlocking edge features are configured to mesh such that the two or more composite panels are disposed at an angle with respect to one another.

8. The system of claim 1, wherein the interlocking edge features are configured to provide an edge joint that is disposed at a compound angle.

9. A method for constructing composite structures, comprising:
constructing two or more composite panels that are flat;
cutting the two or more composite panels into individual shapes;
cutting interlocking edge features for joining the two or more composite panels;
assembling the two or more composite panels; and
curing an adhesive for permanently affixing the two or more composite panels.

10. The method of claim 9, wherein cutting the two or more composite panels includes using at least a 4-axis cutting machine, such as a tilting head waterjet.

11. The method of claim 9, wherein cutting the interlocking edge features comprises configuring the interlocking edge features to mesh such that the two or more composite panels are disposed at an angle with respect to one another.

12. The method of claim 9, wherein cutting the interlocking edge features comprises configuring the interlocking edge features to provide an edge joint that is disposed at a compound angle.

13. The method of claim 9, wherein cutting the interlocking edge features includes cutting dovetails into at least one edge of each of the two more composite panels.

14. The method of claim 13, wherein cutting the dovetails includes cutting the dovetails such that the interlocking edge features mesh at an angle relative to a plane of either one of the two or more composite panels.

15. The method of claim 14, wherein the angle ranges between greater than 0 degrees and less than 180 degrees.

16. The method of claim 9, wherein assembling includes applying an adhesive to the interlocking edge features.

17. The method of claim 16, wherein assembling includes meshing the interlocking edge features such that the adhesive fills any gaps and bonds the two more composite panels together.

18. The method of claim 9, wherein curing the adhesive includes using a room temperature cure.

19. The method of claim 18, wherein curing the adhesive includes using one or more external jigs to fixate the two or more composite panels while the adhesive cures.

20. The method of claim 19, wherein curing the adhesive includes removing any adhesive that squeezed out of the joints.
